(19) United States
(12) Patent Application Publication
(10) Pub. No.: US 2010/0103504 A1
(43) Pub. Date: Apr. 29, 2010

(54) NANO-ANTENNA ENHANCED IR UP-CONVERSION MATERIALS

(75) Inventor: Nabil M. Lawandy, Saunderstown, RI (US)

Correspondence Address: K&L Gates LLP, STATE STREET FINANCIAL CENTER, One Lincoln Street, BOSTON, MA, 02111-2950, US

(73) Assignee: SOLARIS NANOSCIENCES, INC., Providence, RI (US)

(21) Appl. No.: 12/581,445

(22) Filed: Oct. 19, 2009

Related U.S. Application Data
(60) Provisional application No. 61/106,375, filed on Oct. 17, 2008.

(51) Int. Cl. G02F 1/35; B05D 5/12; C08K 3/08

(52) U.S. Cl. 359/326; 427/58; 524/439

(57) ABSTRACT

Robust composite materials containing nanoscale antennae for molecules are used in the up-conversion process. Antennae can be used to locally enhance the electric fields near an upconverting phosphor or material to enhance both absorption of energy, such as with a television or radio receiver, and emission of energy, such as by the transmitter at the radio station.

### CROSS-REFERENCE TO RELATED APPLICATIONS

This application claims priority to U.S. Provisional Application Ser. No. 61/106,375, filed Oct. 17, 2008, the entire disclosure of which is incorporated by reference herein.

### FIELD OF INVENTION

The invention relates generally to antennae, and more specifically to antennae enhanced with electromagnetic nanoparticles to enhance infrared up-conversion.

### BACKGROUND

Up-conversion of infrared (“IR”) light has been realized in a number of ways, ranging from multi-photon processes, pair energy transfer in rare earth and phosphor materials, and through phase matched nonlinear processes. All of these approaches have been improved over several years, and in particular in fiber-based geometries where long interaction lengths and high intensities resulting from mode confinement provide obvious advantages.

An obstacle to efficient up-conversion of infrared light is the overall interaction cross section for the up-conversion process. Regardless of the specific mechanism, two or more particles, photons with photons, or photons with phonons must be combined to generate a visible photon in emission. At its basic level, a sensitization problem exists, which requires the cross sections or likelihood of absorption and emission to be greatly enhanced. This is of particular importance when low power fluxes and thin interaction lengths are an additional constraint, such as in a light bulb or other standard illumination source.

A solution to this problem can be best understood in terms of an antenna on a receiver such as a cell phone, radio, or television. For example, a television set without an antenna to capture the incident low power signals works, but not very well.

What is needed, therefore, is a composite material containing antennae to enhance absorption and emission of light in an up-conversion process.

### SUMMARY

Embodiments of the invention include robust composite materials containing nanoscale antennae for molecules participating in the up-conversion process. Antennae can be used to both enhance both absorption of energy and emission of energy.

One embodiment of the invention includes a method for enhancing up-conversion of light by providing composite material and providing a nanostructure antenna embedded in the composite material, wherein the antenna exhibits localized plasmon-polariton resonance.

Another embodiment of the invention includes a material for enhancing up-conversion of light. The material includes a composite substrate and a nanostructure antenna embedded in the composite substrate, wherein nanostructure antenna exhibits localized plasmon-polariton resonance.

Yet another embodiment of the invention includes a coating material for an illumination device. The coating includes a polymer substrate embedded with a plurality of nanostructure antennae. The plurality of nanostructure antennae exhibit localized plasmon-polariton resonance. The coating material is applied to the illumination device and generates up-converted light.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a drawing of the Lycurgus Cup;

FIG. 2 is a schematic diagram of enhanced energy absorption and emission according to an embodiment of the invention;

FIG. 3A is a graph of the spectral response of a nanostructure antenna exhibiting a plasmon response according to an embodiment of the invention;

FIG. 3B is a scanning electron microscope image of a plurality of nanorods according to an embodiment of the invention;

FIG. 4 is a graph depicting the up-converted intensity as a function of input intensity according to an embodiment of the invention; and

FIG. 5 is a scanning electron microscope image of a core-shell structure according to an embodiment of the invention.

### DETAILED DESCRIPTION

The invention will be more completely understood through the following detailed description, which should be read in conjunction with the attached drawings. Detailed embodiments of the invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the invention in virtually any appropriately detailed embodiment.

Antennae are classical electromagnetic resonant structures which scale with the wavelengths involved. For example, an antenna, or “rabbit ears” as they used to be called, are typically about one meter in size, comparable to the approximately one meter wavelength of television signals. According to an embodiment of the invention, antennae for molecules (receivers) interacting with light at the scale of hundreds of nanometers need to be on a similar nano-sized scale, for enhancing both the absorption of infrared light and the emission of visible light.

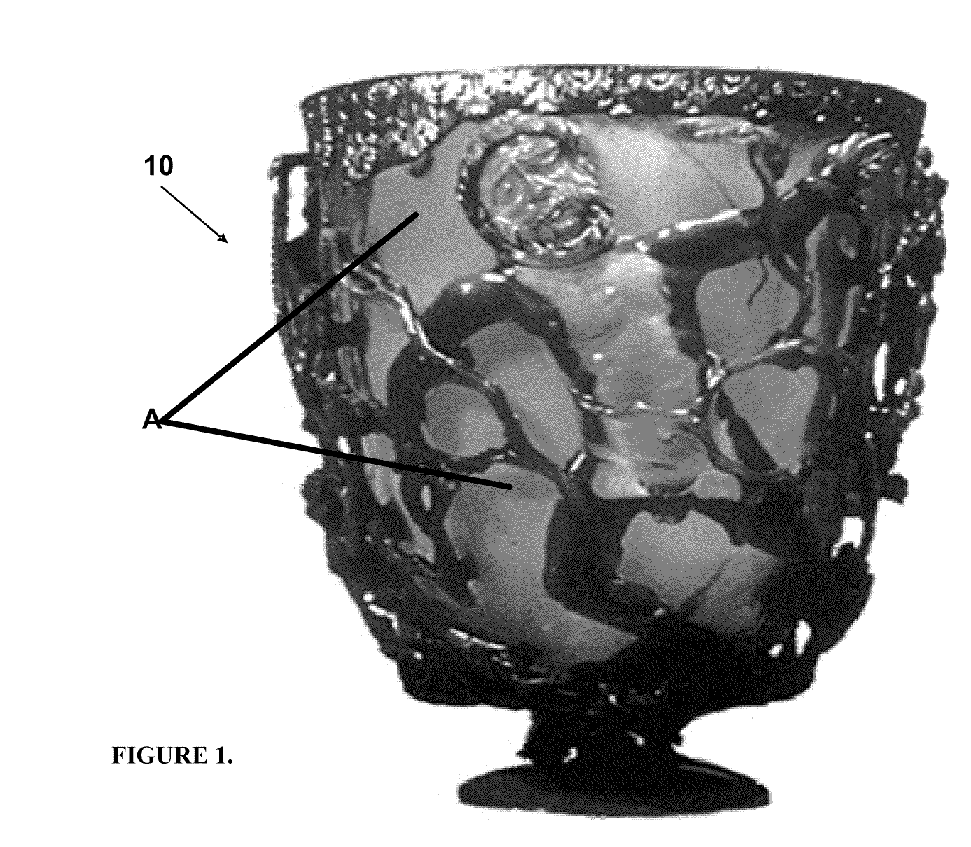

Properties of nanoscale antennae may have been observed twenty centuries ago by the Romans when they placed gold particles in glass and discovered that the doped glass was a deep burgundy red instead of a yellowish and metallic color that might be expected from inclusion of gold particles. An example of this is depicted in FIG. 1, the famous Lycurgus Cup 10 now in the British Museum of Science in London. The red appearance of the doped glass in the cup, denoted as ‘A,’ is due to the intense absorption of green light by the gold particles that reside in the glass as nano-particles with a dimension much smaller than the wavelength of light. The phenomenon was not fully understood until the 1850s when Michael Faraday explained it through the use of classical electrodynamics. Faraday showed that the electromagnetic fields inside and very near the gold particles were greatly enhanced by the collective motion of the electrons in the metal, what is now referred as a localized surface plasmon.

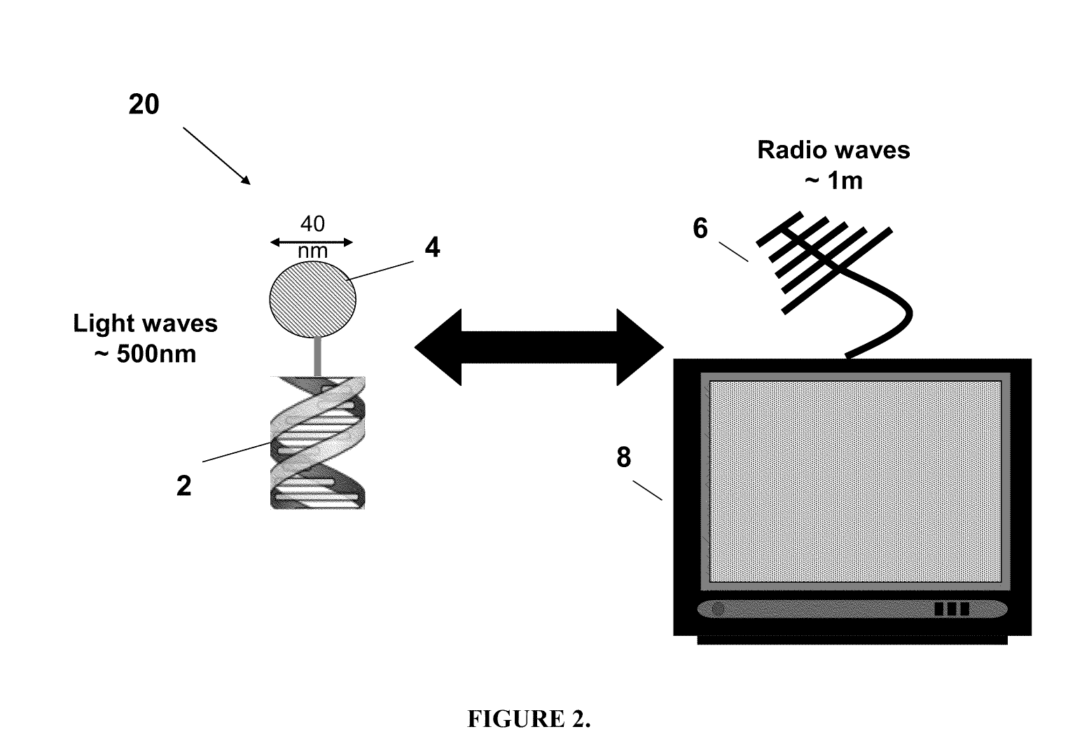

A molecule near the particle surface, which absorbs energy where the plasmon resonance of a nanoscale metallic particle occurs, will experience the enhanced field and absorb energy at a higher rate. Similarly, a molecule radiating where plasmon resonance occur can emit energy faster than it could into free space. Enhanced absorption behavior has been measured by research and development groups at Solaris Nanosciences Corporation in Providence, R.I., using dyes relevant to dye sensitized solar cells. The enhanced absorption and emission process 20 is depicted schematically in FIG. 2. Nanoscale metallic structures 2 act as high-gain antennae for light sensitive molecules 4, similar to a metal rod acting as a gain antenna 6 for a television set 8. When the nanoscale structure is much smaller than the wavelength of light, the structure concentrates, absorbs, and transfers energy. For example, an antenna used to collect approximately one meter wavelength radio waves is sized to a similar one meter length to detect the radio waves in the air. According to one embodiment of the invention, a metallic nanostructure having a dimension of about 40 nanometers, which is much less than the wavelength of visible light (i.e., about 500 nanometers), provides for a significant and measurable up-conversion of infrared light.

According to one embodiment of the invention, synthesized, non-spherical, prolate spheroids or rod shaped nano-particles embedded in polymers exhibit symmetry breaking of the spherical shape, resulting in two plasmon resonances associated with excitation along each axis. According to one embodiment, by a proper choice of the aspect ratio along each axis, two plasmon resonances can be tuned to the infrared spectrum and the visible spectrum for up-conversion applications.

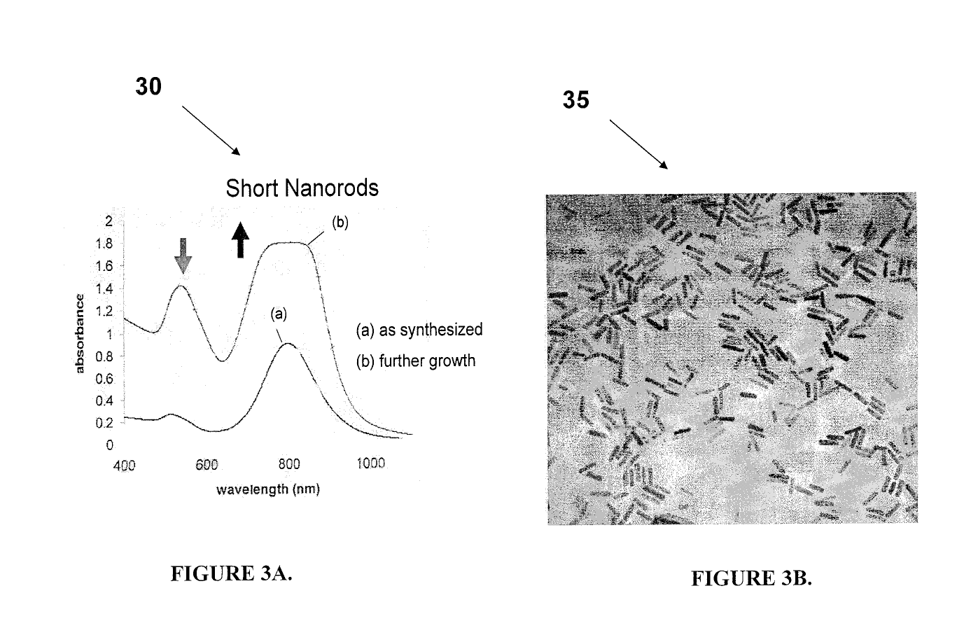

According to one embodiment of the invention, infrared resonance at and near metallic nanostructures enhances the absorption of the light to be up-converted, while the visible resonance enhances the emission of the up-converted light. FIG. 3A shows the spectral response 30 of illustrative gold nanorods synthesized in bulk 35 (shown in FIG. 3B through a scanning electron microscope) and exhibiting an infrared and visible plasmon resonance. As seen in the graph of FIG. 3A, the absorbance by materials having the plasmon enhanced response can be tuned to other wavelengths using the shape of the particle, such as an aspect ratio of length to width. Gold particles shaped as rods can exhibit response and local field enhancements in the infrared spectrum, whereas a spherical particle will exhibit a response only in the visible light portion of the spectrum. Absorption features are present in both the infrared and visible light spectrum in the case of rod-shaped particles.

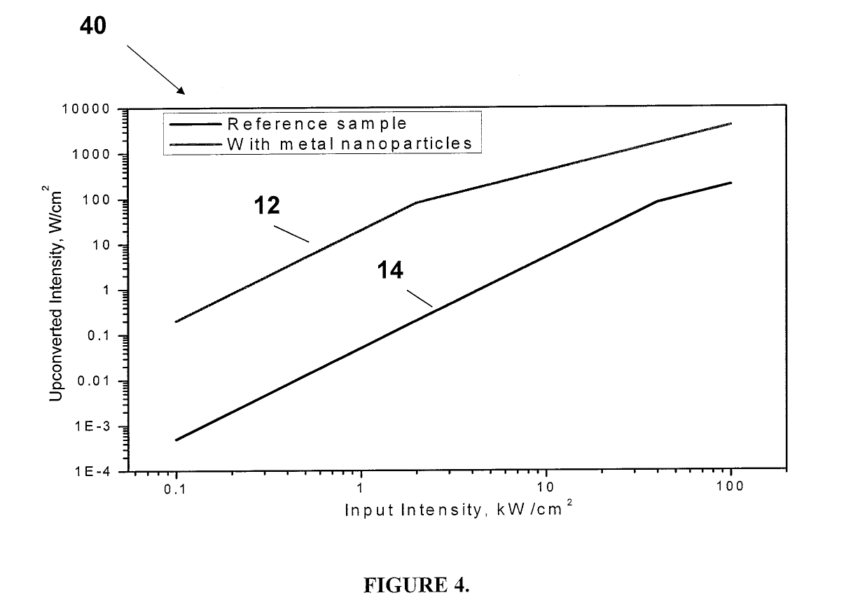

According to an embodiment of the invention, using nano-antenna calculations along with typical up-conversion materials such as YbPO4:Er crystals, Er2Te4O11 nanocrystals, and glass doped with Erbium or Ytterbium (Yr 3 +) at the level of 3×10¹⁹ cm^{31 3}, the enhancement for infrared up-conversion (from ˜980 nm to ˜500 nm) is calculated from the enhanced absorption effect alone. The results of the calculations are depicted in the logarithmic graph 40 of FIG. 4. As seen in the graph, the material having metal nanostructures 12 exhibits a higher upconverted intensity as a function of input intensity that that of a reference sample 14 with no metallic nano structures.

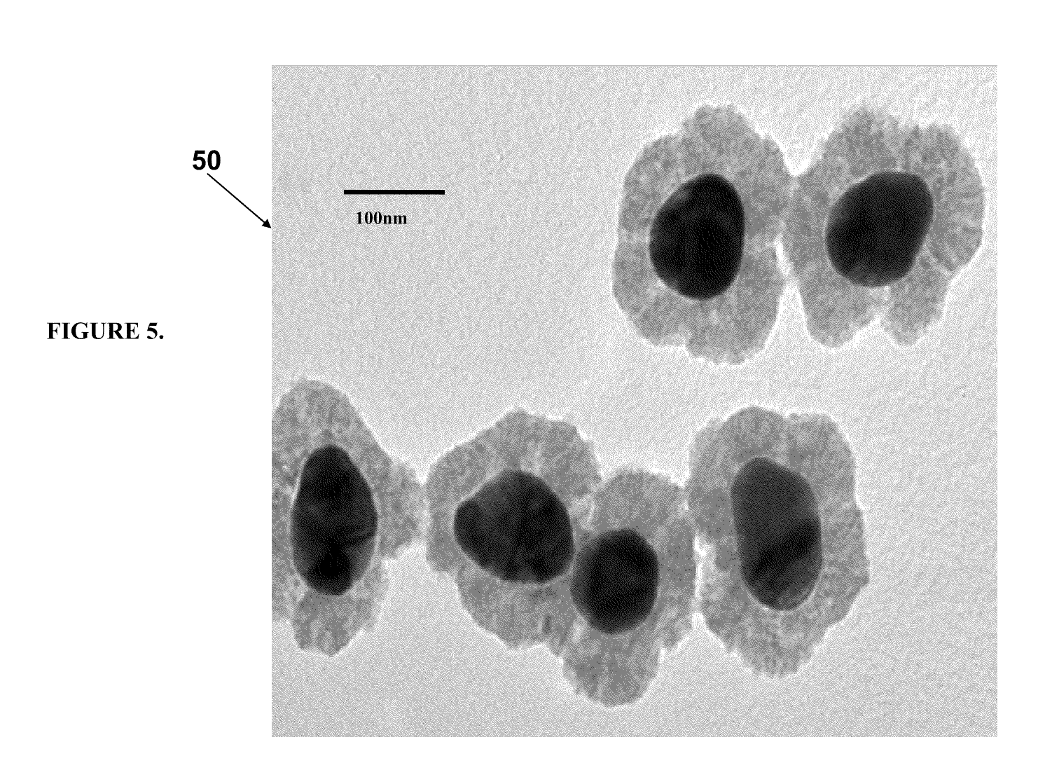

According to one embodiment, the calculations depicted above are based on a core-shell structure such as those shown in the scanning electron microscope image 50 of FIG. 5. The core may be metallic such as gold, silver, or ionic crystals capable of supporting phonon-polariton modes, such as SiC. The shells are upconverting materials including dyes capable of pair energy transfer to higher lying states. Those calculations predict a 400× enhancement of the up-conversion signal for low infrared flux densities as would be encountered in lighting devices.

According to another embodiment, the enhancement is expected to be even higher if a dual-resonance plasmon based on the nanorods described previously were used, effectively enhancing both the receiver and transmitter aspects of the process.

One embodiment of the invention uses engineered nano-particles with infrared and visible nano-antenna responses to create composite materials for efficient up-conversion applications, such as improved lighting. The effect uses chemical synthesis to create cost effective bulk synthesis pathways for nano-antennae as well as optical devices and measurements to characterize the composite material's up-conversion efficiencies. One embodiment of the invention includes a robust coating material, which can be applied to optical glass surfaces to generate the up-converted light.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method for enhancing up-conversion of light comprising:
providing composite material; and
embedding a nanostructure antenna in the composite material such that the antenna exhibit localized plasmon-polariton resonance.

2. The method of claim 1 further comprising:
tuning a first plasmon-polariton resonance across a first axis of the nanostructure antenna to a first wavelength; and
tuning a second plasmon-polariton resonance across a second axis of the nanostructure antenna to a second wavelength.

3. The method of claim 2 wherein the first wavelength is within the infrared spectrum and the second wavelength is within the visible light spectrum.

4. The method of claim 1 wherein the nanostructure antenna is metallic.

5. The method of claim 1 wherein the nanostructure antenna is gold.

6. The method of claim 1 wherein the nanostructure antenna is Erbium.

7. The method of claim 1 wherein the nanostructure antenna is a rod.

8. The method of claim 1 wherein the nanostructure antenna is a prolate spheroid.

9. The method of claim 1 wherein the nanostructure antenna is non-spherical.

10. The method of claim 1 wherein the nanoscale antenna has a dimension smaller than a wavelength of excitation of the localized plasmon-polariton resonance.

11. The method of claim 1 wherein the composite material comprises a polymer.

12. The method of claim 1 wherein the composite material comprises glass.

13. The method of claim 1 further comprising:
coating an illumination device with the composite material and embedded nanostructure antenna.

14. A material for enhancing up-conversion of light comprising:
a composite substrate; and
a nanostructure antenna embedded in the composite substrate, the nanostructure antenna exhibiting localized plasmon-polariton resonance.

15. The material of claim 13 wherein:
a first plasmon-polariton resonance is tuned across a first axis of the nanostructure antenna to a first wavelength, and
a second plasmon-polariton resonance is tuned across a second axis of the nanostructure antenna to a second wavelength,

16. The material of claim 15 wherein the first wavelength is within the infrared spectrum and the second wavelength is within the visible light spectrum.

17. The material of claim 15 wherein the nanoscale antenna is metallic.

18. The material of claim 15 wherein the nanoscale antenna is gold.

19. The material of claim 15 wherein the nanoscale antenna is Erbium.

20. The material of claim 15 wherein the metallic nanostructure is a rod.

21. The material of claim 15 wherein the metallic nanostructure is a spheroid.

22. The material of claim 15 wherein the metallic nanostructure is non-spherical.

23. The material of claim 15 wherein the nanoscale antenna has a dimension smaller than a wavelength of excitation of the localized plasmon-polariton resonance.

24. The material of claim 15 wherein the composite material comprises a polymer.

25. The material of claim 15 wherein the composite material comprises glass.

26. A coating material for an illumination device comprising:
a polymer substrate;
a plurality of metallic nanostructure antennae embedded in the substrate, at least one of the nanostructure antennae exhibiting a localized plasmon-polariton resonance across a first axis of the nanostructure antenna and a plasmon-polariton resonance across a second axis of the nanostructure antenna,
wherein the coating material is applied to the illumination device and generates up-converted light

27. The material of claim 26 wherein the resonance across the first axis tuned to a first wavelength within the infrared spectrum, the resonance across the second axis tuned to a second wavelength within the visible light spectrum.
